(19) United States
(12) Patent Application Publication
(10) Pub. No.: US 2010/0134889 A1
(43) Pub. Date: Jun. 3, 2010

(54) DIFFRACTIVE OPTICAL ELEMENT, OPTICAL SYSTEM AND OPTICAL APPARATUS

(75) Inventor: Hidemi Takayama, Utsunomiya-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/625,685

(22) Filed: Nov. 25, 2009

(30) Foreign Application Priority Data
Nov. 28, 2008 (JP) 2008-304460

(51) Int. Cl. G02B 5/18; G02B 1/04

(52) U.S. Cl. 359/576

(57) ABSTRACT

The diffractive optical element is constituted by a glass material and a resin material whose dn/dT representing refractive index variation with temperature is larger than that of the glass material, the resin material being in close contact with or facing the glass material, and a diffractive grating formed at a close contact portion or a facing portion between the glass material and the resin material. The resin material is a mixture material of (a) a resin base material, (b) first fine particles formed of a first material whose dn/dT is equal to or higher than −1×10⁻⁵(/° C.) and (c) second fine particles formed of a second material whose Abbe constant is lower than that of the glass material. The diffractive optical element can maintain high diffraction efficiency in a wide wavelength region even if temperature changes, without generating unnecessary diffracted light.

### BACKGROUND OF THE INVENTION

The present invention relates to a diffractive optical element used for an optical system such as an image taking optical system.

Methods for reducing chromatic aberrations of an optical system are known which provide a diffractive optical element constituting part of the optical system, the methods being disclosed in “SPIE Vol. 1354 International Lens Design Conference (1990)”, Japanese Patent Laid-Open Nos. 04-213421 and 06-324262, and U.S. Pat. No. 5,044,706.

Such a diffractive optical element has a shape in which a phase term defined by an optical path difference function is added to a base shape. The base shape is, for example, a shape of a surface of a lens constituting an optical system, the shape of the lens surface being a spherical shape, an aspheric shape or a flat surface shape. Moreover, an additional amount of an optical path length due to a structure in which a diffractive grating shape is added to the lens surface is expressed by using an optical path difference function φ(h) defined by φ(h)=(C1h²+C2h⁴+C3h⁶+ . . . )×2π/λ where h represents a height from an optical axis, Pn represents an optical path difference function coefficient of an n-th order (even number order), and λ represents a wavelength.

For example, when a diffractive grating shape (plural orbicular zones) formed according to the optical path difference function φ(h) is concentrically added to a lens surface whose curvature is R, employing a diffractive grating shape satisfying the following expression makes it possible to produce a diffractive lens having a diffraction effect.

$$x = R - \sqrt{{R}^{2} - {h}^{2}} + ( k - \frac{ϕ ( h )}{2 π} ) \times d$$

where x represents a position in an optical axis direction, k represents a number of the orbicular zone counted from a center, and d represents a grating thickness.

In the above expression, the first and second terms indicate the base shape and the third term indicates the phase term defined by the optical path difference function to be added to the base shape. Regarding the second term, the position x becomes discontinuous at portions where the orbicular zone numbers change, which generates a grating shape.

When the diffractive optical element is used in the optical system, it is necessary that diffraction efficiency for a designed diffraction order be sufficiently high in the entire wavelength region of light entering the optical system (hereinafter, the wavelength region of the light is referred to as “use wavelength region”). If the diffraction efficiency for the designed diffraction order is low, a lot of light rays of diffraction orders other than the designed diffraction order exist, and reach other positions where the designed diffraction order light rays do not reach to generate flare.

FIG. 13 shows an example of a conventional diffractive optical element. In a left part of FIG. 13, reference numeral 122 denotes orbicular zones of a diffractive grating of the diffractive optical element. Changing pitches between the gratings makes it possible to provide an optical power. Moreover, in a right part of FIG. 13, a first diffractive grating 135 and a second diffractive grating 136 are disposed so as to face each other with an air layer 133 therebetween. Such a configuration of the diffractive optical element can provide high diffraction efficiency in a wide wavelength region.

FIG. 14 shows another example of a conventional diffractive optical element (multilayer diffractive optical element). Reference numeral 141 denotes a first diffractive grating, reference numeral 142 denotes a second diffractive grating, and reference numeral 143 denotes an air layer. The first diffractive grating 141 and the second diffractive grating 142 are formed of materials having mutually different dispersions (Abbe constants νd). For example, the first diffractive grating 141 is formed of a first ultraviolet curable resin (nd=1.635, νd=23.0), and the second diffractive grating 142 is formed of a second ultraviolet curable resin (nd=1.524, νd=50.8). A grating thickness d1 of the first diffractive grating 141 is 7.8 μm, and a grating thickness d2 of the second diffractive grating 142 is 10.7 μm. A thickness d3 of the air layer 143 is 1.0 μm. A grating pitch is 140 μm, and a designed diffraction order is +1. The diffraction efficiency in this case is approximately 100% for light 144 in the entire visible wavelength region.

FIG. 17 shows a still another example of a conventional diffractive optical element (contact type diffractive optical element). This diffractive optical element has a structure in which a first diffractive grating 51 and a second diffractive grating 52 are in close contact with each other, without having the air layer formed in the multilayer diffractive optical element shown in FIG. 14. In this diffractive optical element, the first diffractive grating 51 is formed of a material having a refractive index lower than that of the second diffractive grating 52. Such a contact type diffractive optical element can be produced by, for example, molding one of the first and second diffractive gratings 51 and 52 by using a glass material and then placing an uncured resin material on the grating of the glass material to cure it.

When n(λ) represents a refractive index of the first diffractive grating 51 formed of a low refractive index material for a wavelength λ, and n′ (λ) represents a refractive index of the second diffractive grating 52 formed of a high refractive index material for the wavelength λ, a phase deviation is expressed by the following expression:

φ(λ)={n′(λ)−n(λ)}d/λ

When m represents a diffraction order, diffraction efficiency η(λ) is expressed by the following expression:

$$η ( λ ) = {[ \frac{sin \{ π ( φ ( λ ) - m \}}{π ( φ ( λ ) - m )} ]}^{2}$$

One of advantages obtained by using glass and resin materials is that a number of selectable materials is increased. Optical glass materials include many glass materials having various combinations of refractive indexes and Abbe constants. On the other hand, optical resin materials include a small number of resin materials, and therefore selectable materials are limited. Moreover, the resin materials generally have lower refractive indexes than those of the glass materials.

It is preferable for producing the multilayer diffractive optical element to combine a material having a low refractive index and a high dispersion and a material having a high refractive index and a low dispersion. Therefore, using one of many types of glass materials enables production of a diffractive grating having higher diffraction efficiency.

Moreover, the above-described method which molds the diffractive grating by using the glass material and places the uncured resin material thereon to cure it is preferable because the glass material is more resistant to ultraviolet light and heat as compared with the resin material, and the grating thickness and the grating shape of the glass material are not changed when the resin material is cured.

Additionally, Japanese Patent Laid-Open No. 2005-338798 discloses that a material in which fine particles are dispersed is used for temperature compensation in a diffractive grating formed by combining resin materials. Moreover, Japanese Patent Laid-Open No. 2005-38481 discloses that producing a single-layer diffractive optical element by using an a thermal material in which inorganic particles are dispersed in a resin material improves its temperature property.

However, while a refractive index variation with temperature (dn/dT) of the resin material is a negative value of −1.0×10⁻⁴(/° C.), dn/dT of the glass material is about 1/10 of that of the resin material and is generally a positive value.

Further, in the diffractive optical element in which the first resin material and the second resin material are combined, a temperature variation of the diffractive optical element due to environmental temperature change or the like generates a phase deviation with respect to a designed additive phase amount since the refractive index variations of the first resin material and the second resin material are different from each other. That is,

φ(λ)={n′(λ)+δn′(λ)−n(λ)−δn(λ)}d/λ

is established, and therefore the diffraction efficiency η is deteriorated by that phase deviation.

In particular, when the diffractive optical element is used for an image taking optical system (image forming optical system), concentric flare light is generated around a high-intensity light source included in a scene for image taking.

Furthermore, Japanese Patent Laid-open No. 2005-338798 does not consider that the fine particles are mixed in the resin material in order to bring dn/dT of the resin material close to dn/dT of a glass material, and only fine-tunes the refractive index and the Abbe constant of the resin material. This is because mixing the fine particles into the resin material for bringing dn/dT of the resin material close to dn/dT of the glass material provides to the resin material a refractive index which makes it difficult to design a diffractive grating capable of obtaining high diffraction efficiency in a wide wavelength region.

Moreover, Japanese Laid-Open No. 2005-38481 discloses a case where the single-layer diffraction optical element is used for a single wavelength such as a laser. Therefore, it is not necessary to improve diffraction efficiency in a wide wavelength region by combining two or more materials. Accordingly, there is no limitation on the refractive index and the Abbe constant of the use material, and it is not necessary to mix two or more materials at all.

### SUMMARY OF THE INVENTION

The present invention provides a diffractive optical element capable of maintaining high diffraction efficiency in a wide wavelength region even if temperature changes, without generating unnecessary diffracted light, and provides an optical system and an optical apparatus using the same.

The present invention provides as one aspect thereof a diffractive optical element including a glass material, a resin material whose dn/dT representing a refractive index variation with temperature is larger than that of the glass material, the resin material being in close contact with or facing the glass material, and a diffractive grating formed at a close contact portion or a facing portion between the glass material and the resin material. The resin material is a mixture material of a resin base material, first fine particles formed of a first material whose dn/dT satisfies a condition of dn/dT≧−1×10⁻⁵(/° C.) and second fine particles formed of a second material whose Abbe constant is lower than that of the glass material.

The present invention provides as other aspects thereof an optical system including the above-described diffractive optical element, and an optical apparatus including the optical system.

Other aspects of the present invention will become apparent from the following description and the attached drawings.

### BRIEF DESCRIPTION OF THE DRAWINGS

FIG. 1 is a cross sectional view of an image taking optical system using a diffractive optical element of Embodiment 1 of the present invention.

FIG. 2 is a cross sectional view and a partially enlarged view of the diffractive optical element of Embodiment 1.

FIG. 3 shows designed diffraction efficiency for first order diffracted light of a diffractive optical element which is a comparative example with respect to Embodiment 1.

FIG. 4 shows diffraction efficiency for the first order diffracted light of the diffractive optical element of the comparative example when temperature thereof rises by 20° C.

FIG. 5 shows designed diffraction efficiency for zeroth order diffracted light and designed diffraction efficiency for second order diffracted light of the diffractive optical element of the comparative example.

FIG. 6 shows diffraction efficiency for the zeroth order diffracted light and diffraction efficiency for the second order diffracted light of the diffractive optical element of the comparative example when the temperature thereof rises by 20° C.

FIG. 7 shows designed diffraction efficiency for first order diffracted light of the diffractive optical element of Embodiment 1.

FIG. 8 shows designed diffraction efficiency for zeroth order diffracted light and designed diffraction efficiency for second order diffracted light of the diffractive optical element of Embodiment 1.

FIG. 9 shows diffraction efficiency for the first order diffracted light of the diffractive optical element of Embodiment 1 when temperature thereof rises by 20° C.

FIG. 10 shows diffraction efficiency for the zeroth order diffracted light and diffraction efficiency for the second order diffracted light of the diffractive optical element of Embodiment 1 when the temperature thereof rises by 20° C.

FIG. 11 shows diffraction efficiency for the first order diffracted light of the diffractive optical element of Embodiment 1 when a mixing ratio of SiO₂ in the element is 50% and the temperature of the element rises by 20° C.

FIG. 12 shows diffraction efficiency for the zeroth order diffracted light and diffraction efficiency for the second order diffracted light of the diffractive optical element of Embodiment 1 when the mixing ratio of SiO₂ in the element is 50% and the temperature of the element rises by 20° C.

FIG. 13 is an explanatory drawing of a conventional multilayer diffractive optical element.

FIG. 14 is an explanatory drawing of another conventional multilayer diffractive optical element.

FIG. 15 shows designed diffraction efficiency for first order diffracted light of a diffractive optical element of Embodiment 2 of the present invention.

FIG. 16 shows designed diffraction efficiency for zeroth order diffracted light and designed diffraction efficiency for second order diffracted light of the diffractive optical element of Embodiment 2.

FIG. 17 is an explanatory drawing of a conventional contact type diffractive optical element.

### DESCRIPTION OF THE EMBODIMENTS

Exemplary embodiments of the present invention will hereinafter be described with reference to the accompanying drawings.

### Embodiment 1

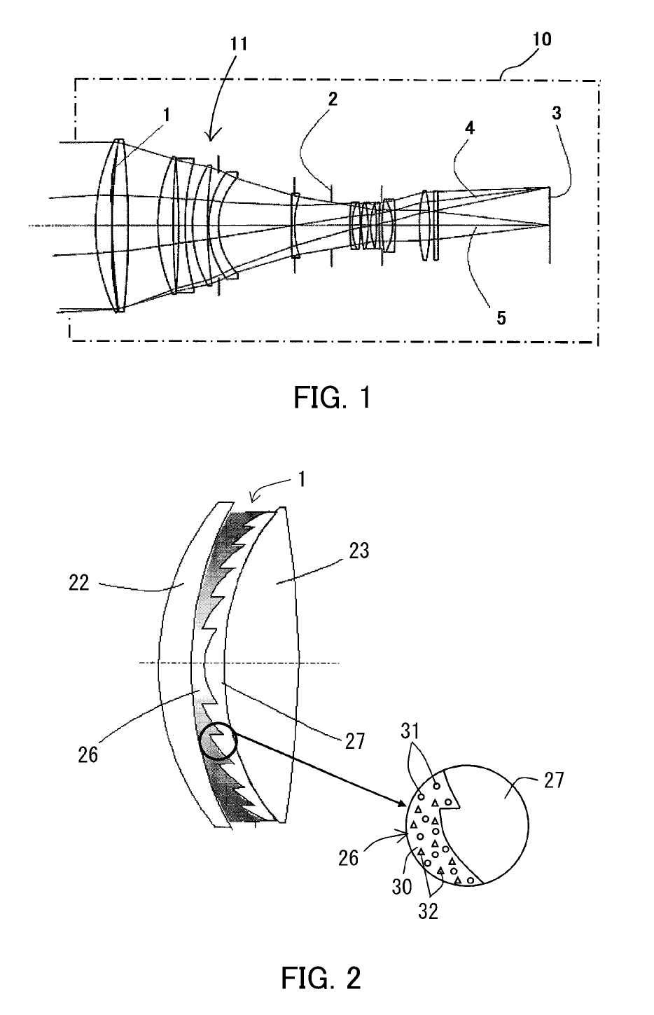

FIG. 1 shows an example of an image taking optical system whose focal length is 400 mm which includes a diffractive optical element of a first embodiment (Embodiment 1) of the present invention. In FIG. 1, reference numeral 10 denotes an image pickup apparatus (optical apparatus) including an image taking optical system 11. The image taking optical system 11 may be detachable as an interchangeable lens (optical apparatus) to a main body of the image pickup apparatus provided with an image pickup element described later.

The image taking optical system 11 has plural lens units from an object side to an image side. Reference numeral 1 denotes the diffractive optical element provided in a first lens unit disposed closest to an object. Reference numeral 2 denotes an aperture stop. Reference numeral 3 denotes the image pickup element such as a CCD sensor or a CMOS sensor which is disposed on an image plane of the image taking optical system 11. Reference numeral 4 denotes a light flux entering the image taking optical system 11 and forming a maximum angle of view. Reference numeral 5 denotes an optical axis of the image taking optical system 11.

In this embodiment, the diffractive optical element 1 is disposed between a first (object side) lens element and a second (image side) lens element that constitute the first lens unit, which makes it easy for light from a high-intensity light source such as the sun to enter the diffractive optical element 1 from an outside of an effective angle of view. As a countermeasure thereagainst, reducing a number of grating walls of a diffractive grating of the diffractive optical element 1 as much as possible, that is, lowering a grating height is effective. Therefore, in the diffractive optical element 1, combining a glass material and a resin material advantageously increases a number of selectable materials as compared with a case where the diffractive grating is provided between resin materials.

On the other hand, in order to use a diffractive optical element for an image taking optical system, it is necessary to suppress a phenomenon of generation of unnecessary diffracted light around a high-intensity light source as much as possible. Therefore, it is important to increase diffraction efficiency, and deterioration of the diffraction efficiency due to variation of a refractive index of the material of the diffractive optical element with environmental temperature change is not permitted.

In the diffractive optical element 1 of this embodiment, a glass material and a resin material whose dn/dT representing a refractive index variation with temperature is larger than that of the glass material are brought into close contact with each other, and the diffractive grating is provided at a close contact portion between the glass material and the resin material.

Next, description will be made of a diffractive optical element as a comparative example with respect to the diffractive optical element 1 of this embodiment. As a glass material, for example, K-VC79 made by Sumita Optical Glass, Inc. is used. As a resin material, a mixture material of a resin base material and fine particles is used. As the resin base material, for example, ultraviolet (UV) curable resin RC1-C001 made by Dainippon Ink And Chemicals (DIC), Inc. is used, and as a material of the fine particles, ITO (Indium Tin Oxide) is used. The ITO fine particles are dispersed (mixed) in the resin base material at a volume ratio of 12.0% with respect to the resin base material.

K-VC79 has a refractive index nd of 1.61038 and an Abbe constant νd of 57.93. The mixture resin material of RC1-C001 and the ITO fine particles (12.0%) has a refractive index nd of 1.5638 and an Abbe constant νd of 23.22.

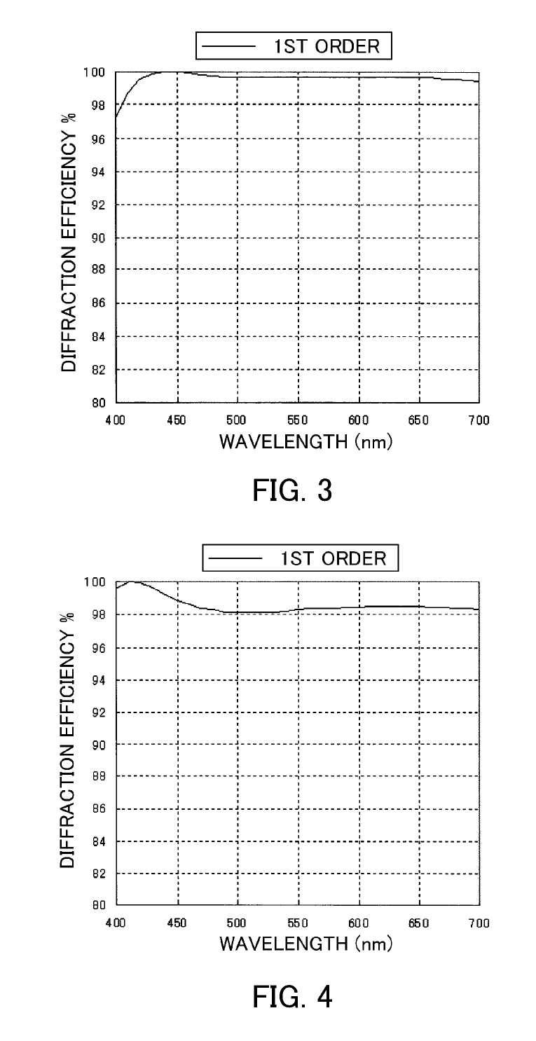

Setting a grating height to 12.6 μm by using these materials provides good diffraction efficiency for first order diffracted light in a wide wavelength range from 400 nm (or about 450 nm) to 700 nm as shown in FIG. 3. FIG. 3 shows diffraction efficiency at a room temperature or a designed temperature (hereinafter referred to as “standard temperature”). The refractive index variation with temperature (hereinafter referred to as “temperature refractive index variation”) dn/dT of the resin material is −1.2×10⁻⁴(/° C.). On the other hand, dn/dT of K-VC79 that is the glass material is approximately 6.0×10⁻⁶(/° C.). In other words, the temperature refractive index variation of the resin material is extremely larger than that of the glass material.

FIG. 4 shows diffraction efficiency of the first order diffracted light in a case where the temperature of the diffractive optical element of the comparative example rises from the standard temperature by 20° C., and thereby refractive indexes of the respective materials are changed. As shown in FIG. 4, the diffraction efficiency at about 500 nm is especially deteriorated to approximately 98%, which is low diffraction efficiency that cannot be ignored in a normal image taking optical system.

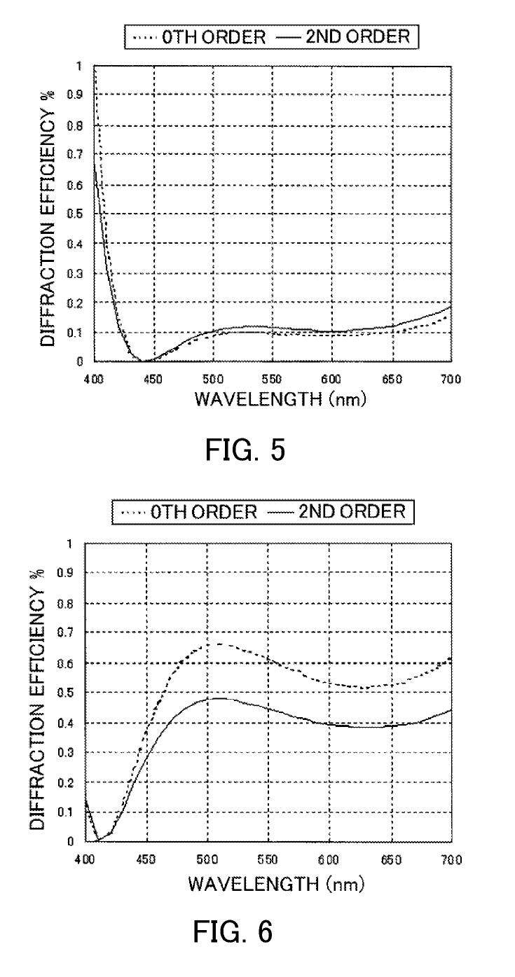

Moreover, FIGS. 5 and 6 show changes of diffraction efficiency for zeroth order diffracted light and diffraction efficiency for second order diffracted light with temperature change in the diffractive optical element of the comparative example. FIG. 5 shows the diffraction efficiency for the zeroth order diffracted light and the diffraction efficiency for the second order diffracted light in a case where each material has a designed refractive index (at the standard temperature). In a wavelength region from about 450 nm to about 700 nm, the diffraction efficiency for each order diffracted light is approximately 0.1%, which is very low.

On the other hand, FIG. 6 shows the diffraction efficiency for the zeroth order diffracted light and the diffraction efficiency for the second order diffracted light when the temperature of the diffractive optical element of the comparative example rises from the standard temperature by 20° C. At a wavelength of about 500 nm, the diffraction efficiency for each order diffracted light is deteriorated to approximately 0.5% or a level exceeding 0.6%. Such deterioration of the diffraction efficiency of each of the zeroth order diffracted light and the second order diffracted light causes, when image pickup is performed for a scene including a high-intensity light source, concentric flare around the light source, which deteriorates a captured image.

FIG. 2 shows the diffractive optical element 1 of this embodiment in detail. The diffractive optical element 1 has a structure in which a diffractive grating is disposed between a first lens element 22 and a second lens element 23, the diffractive grating being formed of an ultraviolet curable resin material 26 whose refractive index for a d-line is nd1 and a glass mold material whose refractive index for the d-line is nd2. The relationship between the refractive indexes is nd1<nd2. The first lens element 22 and the second lens element 23 also serve as substrates for the diffractive optical element.

FIG. 2 includes an enlarged schematic view of part of the ultraviolet curable resin material (hereinafter referred to as “UV curable resin”) 26. The UV curable resin 26 is produced by dispersing (mixing) fine particles (first fine particles) 31 made of silica (silicon dioxide, SiO₂) that is a first material in the RC1-C001 that is the above-described resin base material 30 at a volume ratio of 20% with respect to the resin base material 30.

Although the first material is not limited to silica, it is necessary that the first material satisfy the following condition:

dn/dT≧−1×10⁻⁵(/° C.)

(that is, dn/dT is equal to or higher than −1×10⁻⁵(/° C.))

Further, it is preferable that a particle diameter (average particle diameter) of the silica fine particles 31 be equal to or smaller than 100 nm. It is more preferable that the particle diameter thereof be equal to or smaller than 50 nm. The particle diameter equal to or smaller than 100 nm can reduce light scattering by the silica fine particles 31 dispersed in the resin base material 30 to a level causing largely no problem, and the particle diameter equal to or smaller than 50 nm can reduce light scattering to a level causing almost no problem.

The temperature refractive index variation dn/dT of the UV curable resin 26 that does not contain the silica fine particles 31 is −1.2×10⁻⁴(/° C.), and dn/dT of the silica fine particle 31 is 8.0×10⁻⁶(/° C.). Adding cross-linking agent after the silica fine particles 31 are dispersed in the resin base material 30 can reduce the temperature refractive index variation of the UV-curable resin 26.

However, it is difficult to design a diffractive optical element having high diffraction efficiency in a wide wavelength region only by dispersing the silica fine particles 31. Therefore in this embodiment, fine particles (second fine particles) 32 made of ITO (second material) are also dispersed (mixed) in the resin base material 30, which makes it possible to adjust the refractive index and the Abbe constant of the UV curable resin 26. As a result, the UV curable resin 26 possesses a lower refractive index and a higher dispersion (lower Abbe constant) as compared with the glass mold material 27.

Although the second material is not limited to ITO, it is necessary that the second material have a higher dispersion, that is, a lower Abbe constant as compared with the glass mold material 27.

In this embodiment, the silica fine particles 31 are dispersed in the resin base material (RC1-C001) 30 at a volume ratio of 20% with respect to the resin base material 30, and the ITO fine particles 32 are dispersed therein at a volume ratio of 13.8% with respect thereto. The UV curable resin 26 in which the silica fine particles 31 and the ITO fine particles 32 are dispersed has a refractive index nd of 1.5588 and an Abbe constant νd of 21.6. As a result, dn/dT of the UV curable resin 26 is −9.4×10⁻⁵(/° C.), which is smaller that that of the resin base material (RC1-C001).

It is preferable that a mixing ratio in volume of the first fine particles such as silica fine particles to the resin base material be equal to or higher than 20%.

On the other hand, the glass mold material 27 is K-VC79 (nd=1.6103, νd=57.9) described above. Although the glass mold material 27 is not limited to K-VC79, it is preferable that the glass mold material be a low melting point glass whose glass transition temperature is equal to or lower than 600° C. (for example, 600° C. or less and 500° C. or more).

After a diffractive grating whose grating height is 11.4 μm is formed by a glass molding technology, uncured UV curable resin 26 is placed on a surface of the grating, and then the UV curable resin 26 is irradiated with ultraviolet light to be cured. As a result, a contact type diffraction optical element is formed.

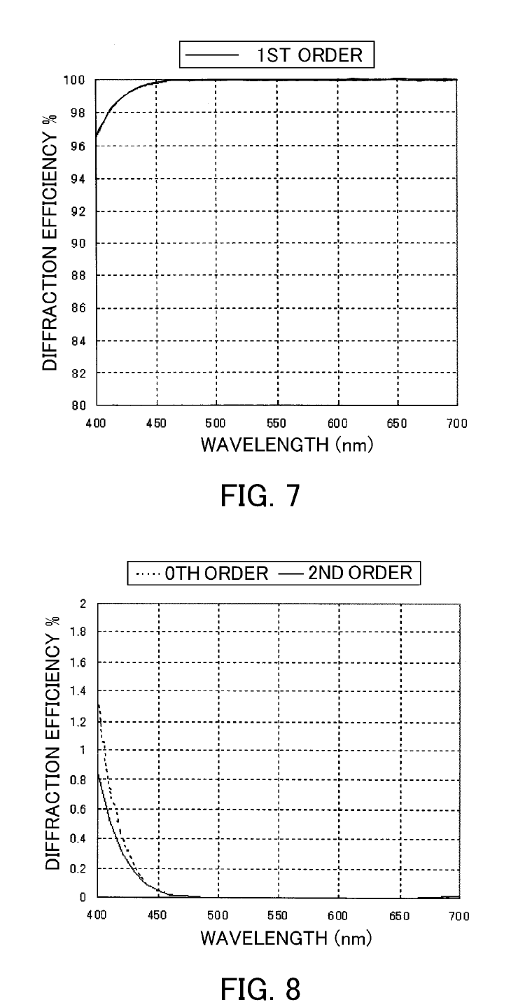

FIG. 7 shows diffraction efficiency for the first order diffracted light, which is designed order diffracted light, of the diffractive optical element 1 of this embodiment at the standard temperature. The diffraction efficiency is approximately 100% in the wavelength region from about 450 nm to about 700 nm. FIG. 8 shows diffraction efficiency for the zeroth order diffracted light and diffraction efficiency for the second diffracted light of the diffractive optical element 1 of this embodiment at the standard temperature. As is understood from FIG. 8, the diffraction efficiency for each of the zeroth order diffracted light and the second diffracted light is extremely low in the wavelength region from about 450 nm to about 700 nm, which indicates an excellent performance.

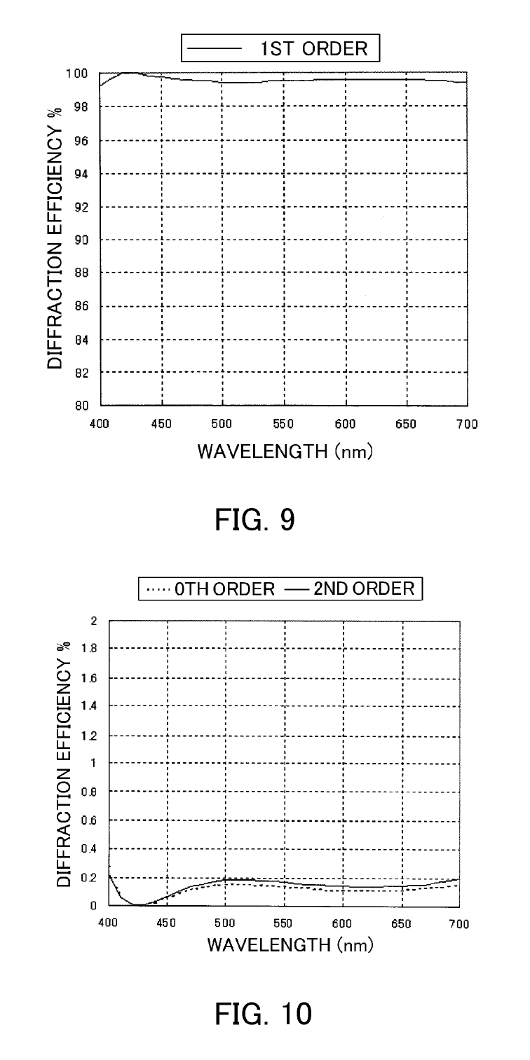

Furthermore, FIG. 9 shows diffraction efficiency for the first order diffracted light of the diffractive optical element 1 of this embodiment when the temperature of the diffractive optical element 1 rises from the standard temperature by 20° C. Deterioration of the diffraction efficiency is less than that shown FIG. 7, and the diffraction efficiency is maintained at 99% or more. FIG. 10 shows diffraction efficiency for the zeroth order diffracted light and diffraction efficiency for the second diffracted light of the diffractive optical element 1 of this embodiment when the temperature rises from the standard temperature by 20° C. The diffraction efficiency is a low value of about 0.2%, which is a sufficient practical level.

Increasing the mixing ratio (volume ratio) of the silica fine particles 31 can reduce the temperature refractive index variation. Since the silica fine particle 31 is transparent, the increase of the mixing ratio causes no reduction of transmittance. Actually, there is a report example in which silica fine particles are dispersed in acrylic resin at 60% by weight (Industrial Material vol. 53 No. 7, 2007), which shows that it is easy to disperse (mix) the silica fine particles in the resin material.

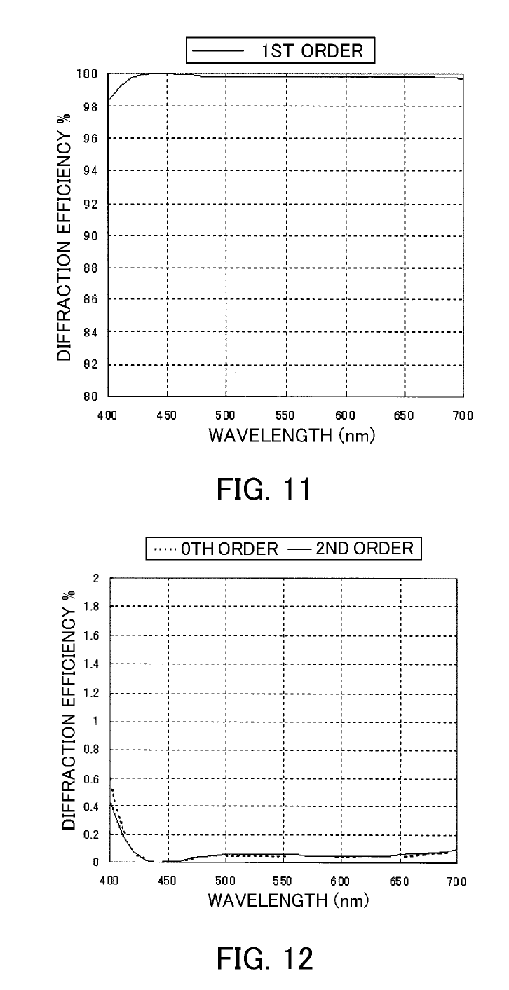

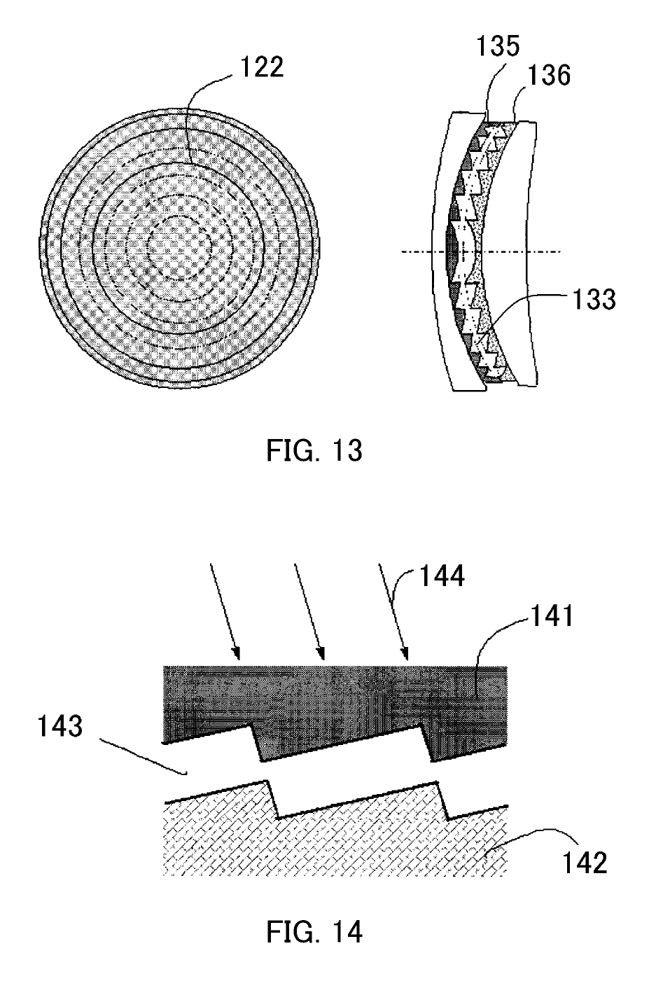

FIG. 11 shows diffraction efficiency for the first order diffracted light of the diffractive optical element 1 of this embodiment in which the mixing ratio of the silica fine particles 31 is increased to 50% to improve dn/dT of the UV curable resin 26 to −5.6×10⁻⁵(/° C.) when the temperature rises from the standard temperature by 20° C. Although the diffractive optical element is produced by combining the resin material and the glass material, deterioration of the diffraction efficiency is suppressed extremely small. FIG. 12 shows diffraction efficiency for the zeroth order diffracted light and diffraction efficiency for the second order diffracted light of the same diffractive optical element 1 when the temperature rises from the standard temperature by 20° C. The diffraction efficiency for each of the zeroth order diffracted light and the second order diffracted light at a wavelength of about 500 nm is approximately 0.05%, and deterioration of the diffraction efficiency is suppressed extremely small.

### Embodiment 2

Next, description will be made of a diffractive optical element which is a second embodiment (Embodiment 2) of the present invention. This diffractive optical element is used for optical systems such as an image taking optical system, as well as the diffractive optical element of Embodiment 1. In general, a refractive index of a substance decreases with rise of its temperature.

When Ct represents a linear expansion coefficient, a temperature refractive index variation dn/dT is expressed as follows:

$$\frac{d n}{d T} = ( n - 1 ) ( - 3 Ct + \frac{1}{R} \cdot \frac{\partial R}{\partial T} )$$

The second term of the above expression relates to the temperature refractive index variation, which can be ignored in many cases. Therefore, dn/dT can be approximated to −3Ct(n−1) in such cases. Since the linear expansion coefficients of many substances are positive value, dn/dT thereof is a negative value.

However, inorganic materials include a material having a negative linear expansion coefficient which is resulted from its volume reduction due to distortion of its crystal lattice with temperature rise. In such a material, dn/dT is a positive value.

In the diffractive optical element of this embodiment, dn/dT is suppressed by dispersing fine particles (first fine particles) made of Niobium Oxide (Nb₂O₅) (first material), which is known as a material having a negative linear expansion coefficient, in RC1-C001 which is a resin base material. Moreover, as well as the diffractive optical element 1 of Embodiment 1, ITO fine particles are dispersed in RC1-C001 to maintain high diffraction efficiency in a wide wavelength region.

Specifically, the Niobium Oxide fine particles are dispersed and mixed in RC1-C001 at a volume ratio of 20% with respect to RC1-C001, and the ITO fine particles are dispersed and added in RC1-C001 at a volume ratio of 10% with respect to RC1-C001. Thereby, UV curable resin having a refractive index nd of 1.7366 and an Abbe constant νd of 18.16 is produced. In this UV curable resin, dn/dT is improved to approximately 7.6×10⁻⁵(/° C.).

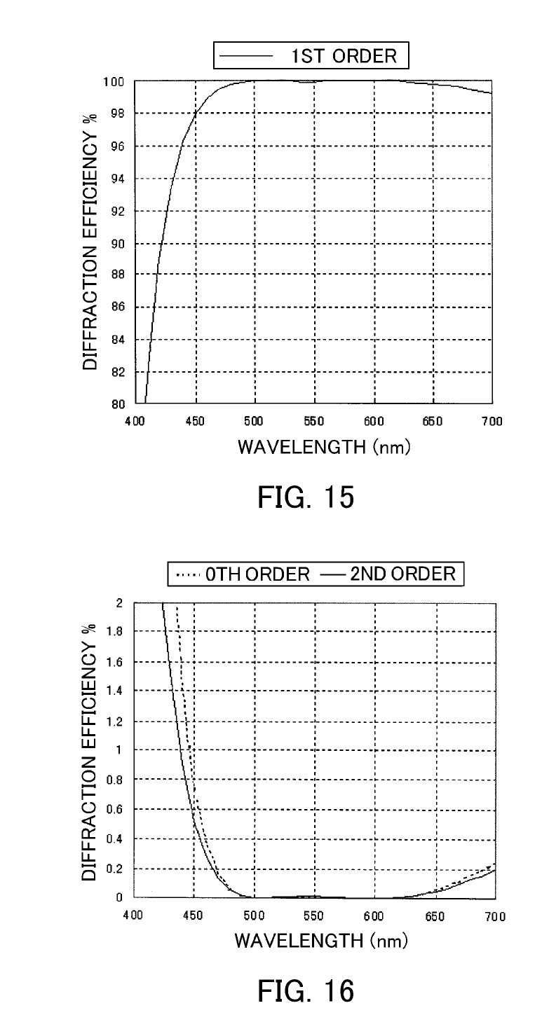

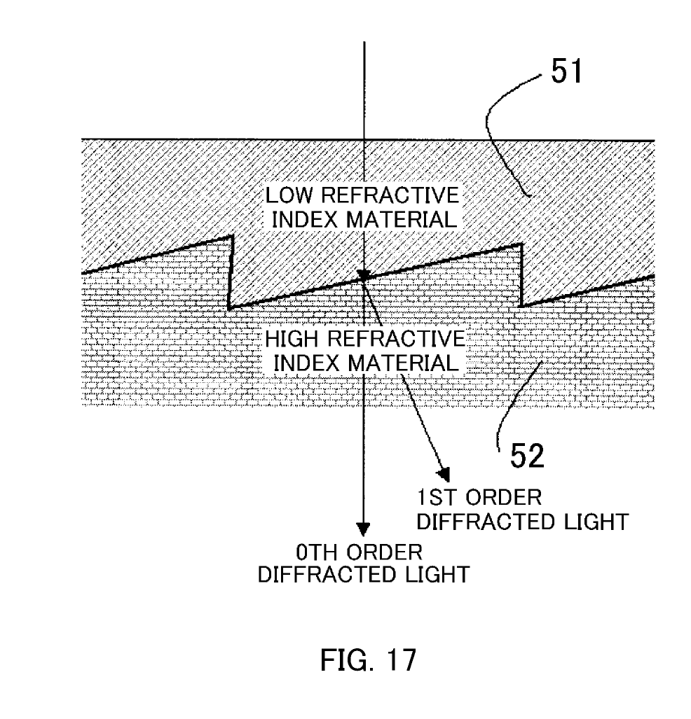

As a glass material, K-VC89 (nd=1.81004, νd=40.11) made by Sumita Optical Glass, Inc. is used. A grating height is set to 7.9 μm. As a result, good diffraction efficiency can be basically secured as shown in FIG. 15.

As shown in FIG. 15, although diffraction efficiency for the first order diffracted light in a wavelength region from about 500 nm to about 700 nm is good, diffraction efficiency at a wavelength of about 400 nm, which is however in an unnoticeable color region, is deteriorated to an unignorable level. Such deterioration of the diffraction efficiency can be reduced by adding other fine particles to the resin base material so as to fine-tune physical property values of the resin material or by changing the glass material.

FIG. 16 shows diffraction efficiency for zeroth order diffracted light and diffraction efficiency for second order diffracted light of the diffractive optical element of this embodiment. The diffraction efficiency for each order diffracted light has a good value in the wavelength region from about 500 nm to about 700 nm.

This embodiment described the case where the fine particles made of niobium oxide having a negative linear expansion coefficient are dispersed in the resin base material. However, materials having a negative linear expansion coefficient other than niobium oxide include zirconium tungstate (ZrW₂O₈) and Si oxide (Li₂O—Al₂O₃-nSiO₂). Dispersing fine particles made of these materials in the resin base material makes dn/dT of the resin material positive.

Moreover, recent researches reported that, in a material having manganese nitride (Mn₃XN) as a basic structure, adding germanium (Ge) to the X part therein provides a negative linear expansion coefficient. Dispersing fine particles made of this material in the resin base material can suppress the temperature refractive index variation of the resin material.

Moreover, many inorganic materials have a positive value as dn/dT. Dispersing fine particles made of, for example, aluminum oxide, beryllium oxide, calcium carbonate, potassium titanyl phosphate, magnesium oxide, tellurium oxide, yttrium oxide and zinc oxide in the resin base material can suppress the temperature refractive index variation of the resin material.

However, it is necessary to add the fine particles made of the second material which is a material having a high dispersion to the resin base material in order to obtain high diffraction efficiency of the diffractive optical element over a wide wavelength region.

Further, although various materials mentioned above can be selected from a viewpoint of the refractive index and the linear expansion coefficient, it is necessary that attention be paid to a material having an extremely low transmittance in some fields in which the low transmittance material is used. Although a material having a high transmittance such as SiO₂ causes no problem, it is necessary to consider that increasing an additive amount of the fine particles made of the second material increases influence on the transmittance.

As described above, according to each embodiment, use of the resin material in which the first fine particles are dispersed in the resin base material can easily bring dn/dT of the resin material close to dn/dT of the glass material. As a result, deterioration of the diffraction efficiency with temperature change can be prevented. Further, dispersing the second fine particles in the resin base material for adjusting dispersion characteristics of the refractive index can realize a diffractive optical element having high diffraction efficiency in a wide wavelength region.

While the present invention has been described with reference to an exemplary embodiment, it is to be understood that the invention is not limited to the disclosed exemplary embodiment. The scope of the following claims is to be accorded the broadest interpretation so as to encompass all modifications, equivalent structures and functions.

For example, each of the above embodiments described the contact type diffractive optical element in which the resin material and the glass material are in close contact with each other and the diffractive grating is formed at the close contact portion between the resin material and the glass material. However, an alternative embodiment of the present invention includes a multilayer diffractive optical element in which a resin material and a glass material face each other with an air layer therebetween and a diffractive grating is formed at a facing portion between the resin material and the glass material.

Moreover, each of the above embodiments described the case where the diffractive optical element is used for the image taking optical system. However, an alternative embodiment of the present invention includes a case where the diffractive optical element is used for optical systems other than the image taking optical system (or for optical apparatuses other than the image pickup apparatus).

This application claims the benefit of Japanese Patent Application No. 2008-304460, filed on Nov. 28, 2008, which is hereby incorporated by reference herein in its entirety.

What is claimed is:

1. A diffractive optical element comprising:
a glass material;
a resin material whose dn/dT representing a refractive index variation with temperature is larger than that of the glass material, the resin material being in close contact with or facing the glass material; and
a diffractive grating formed at a close contact portion or a facing portion between the glass material and the resin material,
wherein the resin material is a mixture material of (a) a resin base material, (b) first fine particles formed of a first material whose dn/dT satisfies a condition of dn/dT≧−1×10⁻⁵(/° C.) and (c) second fine particles formed of a second material whose Abbe constant is lower than that of the glass material.

2. A diffractive optical element according to claim 1, wherein at least one of the first fine particles and the second fine particles are particles whose particle diameter is equal to or smaller than 100 nm.

3. A diffractive optical element according to claim 1, wherein a mixing ratio in volume of the first fine particles to the resin base material is equal to or higher than 20%.

4. A diffractive optical element according to claim 1, wherein the resin material has a lower refractive index and a lower Abbe constant than those of the glass material.

5. A diffractive optical element according to claim 1, wherein the glass material is a low melting point glass whose glass transition temperature is equal to or lower than 600° C.

6. An optical system comprising:
a diffractive optical element,
wherein the diffractive optical element comprising:
a glass material;
a resin material whose dn/dT representing a refractive index variation with temperature is larger than that of the glass material, the resin material being in close contact with or facing the glass material; and
a diffractive grating formed at a close contact portion or a facing portion between the glass material and the resin material,
wherein the resin material is a mixture material of (a) a resin base material, (b) first fine particles formed of a first material whose dn/dT satisfies a condition of dn/dT≧−1×10⁻⁵(/° C.) and (c) second fine particles formed of a second material whose Abbe constant is lower than that of the glass material.

7. An optical apparatus comprising:
an optical system including a diffractive optical element,
wherein the diffractive optical element comprising:
a glass material;
a resin material whose dn/dT representing a refractive index variation with temperature is larger than that of the glass material, the resin material being in close contact with or facing the glass material; and
a diffractive grating formed at a close contact portion or a facing portion between the glass material and the resin material,
wherein the resin material is a mixture material of (a) a resin base material, (b) first fine particles formed of a first material whose dn/dT satisfies a condition of dn/dT≧−1×10⁻⁵(/° C.) and (c) second fine particles formed of a second material whose Abbe constant is lower than that of the glass material.
